(19) United States
(12) Patent Application Publication
(10) Pub. No.: US 2019/0353491 A1
(43) Pub. Date: Nov. 21, 2019

(54) Vehicle Navigation System

(71) Applicant: Ford Global Technologies, LLC, Dearborn, MI (US)

(72) Inventors: Danielle Rosenblatt, Dearborn, MI (US); Hamid Golgiri, Livonia, MI (US); Anthony Melatti, Dearborn, MI (US); Jack Van hoecke, Livonia, MI (US)

(73) Assignee: Ford Global Technologies, LLC, Dearborn, MI (US)

(21) Appl. No.: 16/416,023

(22) Filed: May 17, 2019

(30) Foreign Application Priority Data
May 21, 2018 (GB) 1808317.0

(51) Int. Cl. G01C 21/34

(52) U.S. Cl. CPC G01C 21/3438; G01C 21/3484

(57) ABSTRACT

A vehicle navigation system for a plurality of users, comprising: a sensor provided to each user and configured to collect location data; a controller configured to receive and analyse the location data in order to produce congregation information, comprising information on the number of system users who are congregating at a venue; wherein the congregation information and location data are used to navigate a vehicle to a venue, the venue being determined using the congregation data.

### TECHNICAL FIELD

This invention relates to the field of vehicle navigation, and particularly although not exclusively, relates to using data collected from a plurality of users to select a destination and navigate a vehicle to the selected destination.

### BACKGROUND

Traditional vehicle navigation systems direct vehicles to a destination independently chosen and requested by a user. Many ride hailing and ride sharing services use navigation systems which are enhanced to provide a means of connecting drivers and passengers according to their preselected departure and arrival destinations. Such systems are designed to optimize time but overlook many aspects of the user experience.

These existing systems match users according to routes, for example, if two users hail a ride to a grocery store at the same time, the system will match them, and arrange for them to be driven together.

However, upon arrival at the grocery store, an individual may find the grocery store too busy. This can reduce the quality of the experience for an individual and can often leave the person feeling disappointed in the grocery store visit and wishing they had opted to go elsewhere. There is a need for a system that can provide a user with guidance on crowding in order to direct the user to a suitable and desirable venue before embarking on their journey.

Such a system could be very beneficial for the purpose of crowd prevention by navigating individuals to alternative venues.

Since conventional systems optimise time, strangers can often be matched solely on location and in doing so, experience a ride in uncomfortable silence. Many people today utilize matchmaking services to meet new people in their otherwise busy lives. This can bring together people they normally wouldn't meet. Ride coordinating is an ideal environment for a person to meet people outside their current circle, however vehicle navigation systems are currently not utilized in this way.

In addition, there is a need for a system capable of actively encouraging engagement and participation of individuals in a manner tailored to the individual, by learning about a user from their activity on such systems.

### STATEMENTS OF INVENTION

According to the present invention there is provided a vehicle navigation system for a plurality of users, comprising: a sensor provided to each user and configured to collect location data; a controller configured to receive and analyse the location data in order to produce congregation information, comprising information on the number of system users who are congregating at a venue; wherein the congregation information and location data are used to navigate a vehicle to a venue, the venue being determined using the congregation data.

The controller may be further configured to match users according to attributes.

The controller may be further configured to derive attributes using information collected from external systems or networks.

The system may be further configured to provide a user with congregation information.

The system may be further configured to provide a suggested destination to a user. For example, the system may suggest a destination or a route of travel. Suggested destinations may be determined by their profile and/or behaviour and/or congregation information.

The system may be further configured to provide users with ranked suggestions of venues.

The controller may be further configured to match users according to self-entered in-ride communication preferences.

The controller may be further configured to match users according to correlations in activity and encouraged to coordinate journeys.

The system may be further configured to allow users to block other users from future matching.

The system may be further configured to provide users with access to matched user profiles for the duration of the journey only.

According to another aspect of the present invention there is provided a vehicle comprising the vehicle navigation system.

According to another aspect of the present invention there is provided a method for vehicle navigation comprising the steps of: providing a sensor to a plurality of users; collecting location data from each sensor; sending the location data to a controller, producing congregation information by analysing the location data, using the congregation information and location data to navigate a vehicle to a venue, the venue being determined using the congregation data.

The method may further comprise providing users with a profile and enabling users to input attributes and/or derive attributes from external systems or networks.

The method may further comprise the step of: providing users with a list of venues ranked by congregation information.

The method may further comprise the step of: providing users with suggestions of venues to visit, determined by their profile and/or behaviour and/or congregation information.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1a is a schematic diagram of a vehicle navigation system;

FIG. 1b is a schematic diagram of a vehicle navigation system in operation;

FIG. 2 is a flow chart of a method of matching users;

FIGS. 3a and 3b are schematic diagrams of two examples of configurations of the user interface; and

FIG. 4 is a flow chart of a method of navigating a vehicle.

### DETAILED DESCRIPTION

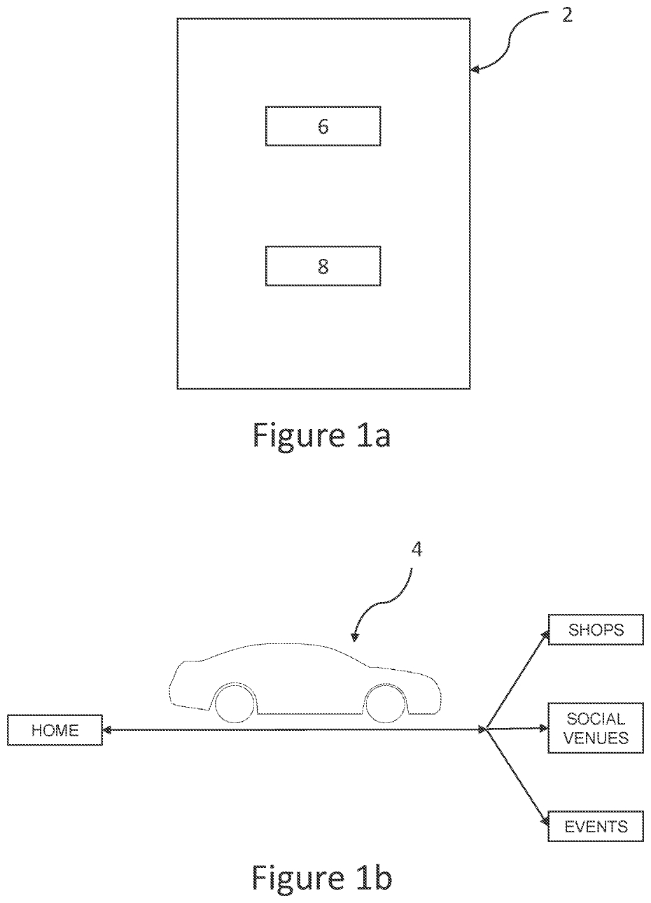

With reference to FIG. 1a, a vehicle navigation system 2 may be configured to collect location data from a plurality of users and generate congregation information, comprising information on the number of system users who are congregating at a venue. With reference to FIG. 1b, the vehicle navigation system 2 may be configured to use the congregation information to determine a venue in order to navigate a vehicle 4 to the venue.

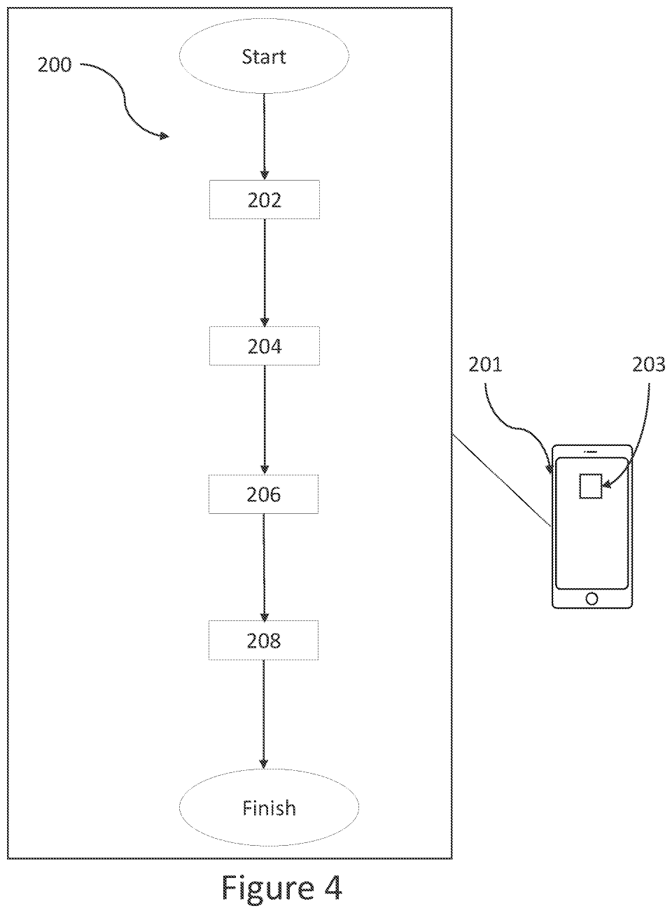

The system 2 comprises a controller 6 and a sensor 8 provided to each user. The sensor 8 is configured to collect location data such as longitude and latitude from each user. The sensor 8 may also be configured to determine the orientation of the vehicle 4. The location of the user may be determined using a satellite navigation system (such as GPS) located within a personal device 201 (shown in FIG. 4) such as a smart phone. The location of a user is sent from the personal device to the controller 6. The controller 6 may be configured to store and monitor user's current and final destinations, thereby creating a record of activity associated with each profile.

The system 2 may track the location of users all the time, or during a predefined period of use. For example, the system 2 may be configured to track the location of users only during the ride, when hailing or ending a ride and/or when active on the system 2.

The location data is also used by the system 2 in determining the optimal route to a venue. The route may be determined using algorithms which may use congregation information to deduce traffic levels. The traffic levels deduced may influence the route selection. The system may use a vector map to determine the optimal route, the map may be stored in the system or alternatively, the system may be configured to refer to a database to collect the required data.

The system 2 may provide a profile to each user. The profile may be stored on the controller 4 or may be accessible by referring to a database.

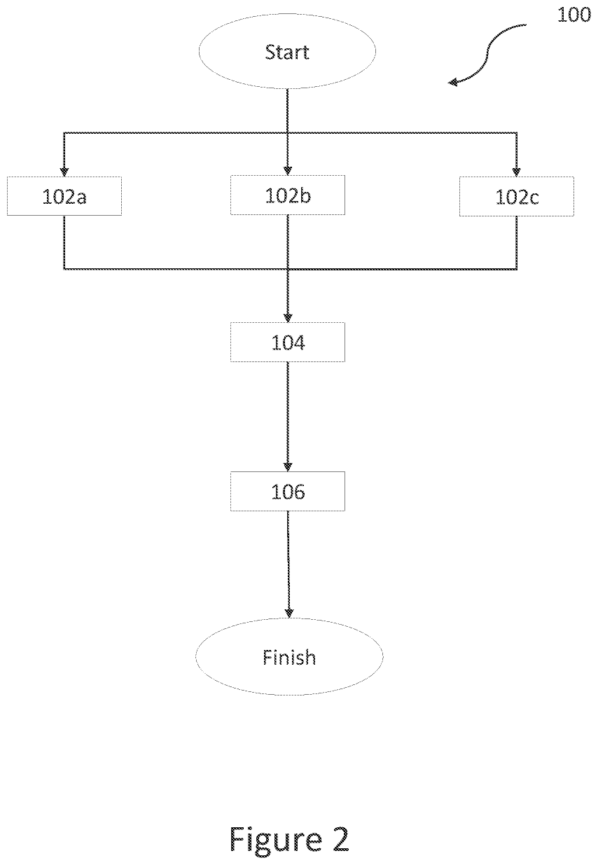

With reference to FIG. 2, the system 2 may be configured to perform a method 100 of matching users comprising steps 102 to 106. At step 102a, the system enables a user to enter attributes. At step 102b, the system acquires or deduces attributes from information collected from an external system. At step 102c, the system determines attributes by analysing the user's behaviour. At step 104, the system collates the attributes into a profile, unique to each user. At step 106, the system matches profiles of users with compatible attributes.

To perform step 102b, the system may be configured to interface with at least one external network. The external network may be a social media platform, for example. The system 2 may only extract data across the interface and may not return any data to the external network. Examples of data that may be extracted include interests and frequently visited locations associated with a user's external network profile.

An example of a scenario which uses information acquired from external networks occurs when the system 2 determines the music interests of a user by identifying the artists or bands that they are following on a social media site. This information can be used to form an attribute that is populated onto the profile of the user. The attribute may be made visible to the driver upon matching so as to indicate to the driver which type of music may be enjoyed by the passenger during the ride. The passenger may be provided with a list of suggested topics of information, as provided by the driver upon creation of a profile. These pointers can be very useful in prompting the passenger to start a conversation with the driver which is well-suited to their mutual interests. The provision of such information can be very beneficial in improving the enjoyment of the ride for a driver and a passenger.

In addition to improving the in-ride experience, the system 2 may be configured to provide matched profiles to users in advance of the planned departure time to give the user the opportunity to select an appropriate or preferred match. The system 2 may be configured to allow users to reject matches, prompting the system to generate alternative matches. By displaying all or a portion of the matched user's profile, the user can browse the profile to decide for themselves if they want to be driven by, drive, or share a ride with the matched user. Offering users control in the selection of one or more users to ride with can increase user's confidence when embarking on a ride. Providing a photo for example can facilitate in the identification of a user. This can speed up the meeting part of the process thereby reducing the standing time of the vehicle 4. This can have the effect of improving the efficiency of a journey which is particularly significant for drivers using the system 2 commercially.

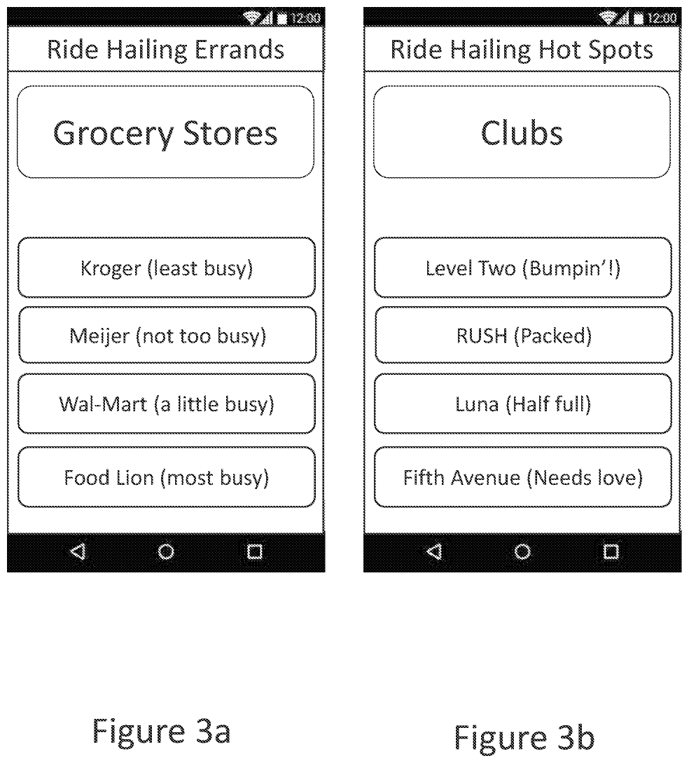

With reference to FIGS. 3a, 3b and 4, congregation information may be conveyed to the user through a user interface 200 which may be provided on a smart phone 201.

For examples in which the system is used to provide an enhanced ride hailing service, the number of rides being hailed from and/or to a particular location may be used as a means for indicating how busy the chosen location is. The current location of users may also be used to generate this information.

The level of crowding of a location can be a desirable or an undesirable attribute. This can depend on the type of place and the preference of the person travelling.

The system may be configured to assess whether overcrowding or under crowding is desirable at a location. For example, overcrowding at a grocery store may be undesirable for users who do not like crowds of people. However, overcrowding at a club or bar may indicate popularity which may be desirable to a user.

An example of a scenario which uses congregation information occurs when a user, identified as disliking crowds, requests to be navigated to a grocery store. The system assess the relative crowding of grocery stores in an area of interest. If the location of many users is identified to be at or near to one particular grocery store, the system 2 may identify the grocery store as ‘crowded’. The system 2 uses the results of the assessment to rank the grocery stores in order of crowding and displays to the user a list of grocery stores in order of compatibility. In addition to providing the ranked list, each grocery store may appear to the user with a status or description of the level of crowding. The status may indicate relative crowding. Such statuses may include “least busy”, “not too busy”, “a little busy” and “most busy”.

The level of crowding may be determined using additional data such as data on the size or capacity of a location, venue or area. This information can be used to enhance the usefulness of the crowding status by giving allowance to the size of different venues.

Providing such information to a user by displaying descriptions on a user's phone enables them to make better informed decisions about where to go for errands and/or social activities. The system 2 can be particularly beneficial for users who do not like, or struggle to be in crowded environments. It can help users choose desirable locations for social activities. The information can aid businesses by dissuading users from choosing to go to particular shops at peak times, for example. This can have the effect of smoothing out the supply of customers or encouraging a better spread of customers across businesses. Since crowding can be positive or negative, this can have the effect of encouraging crowds to form, grow or shrink.

In an alternative example, the system 2 is configured to monitor a user's activity and provide suggestions based on behavior such as patterns in historic rides. By analysing a user's behavior, the system 2 can offer a user a variety suggestions that can be grouped into categories. Three examples of such categories are: proposing a venue (without direct input from the user), proposing matches suitable for coordinating rides and proposing a venue based on a match.

Firstly, the system 2 may be configured to suggest socializing after a long period without engaging in social activities. Behavioral information can be analysed to draw conclusions. For example, if a user is found to have been away from a club for a long time the system 2 may suggest a venue for socializing, and navigate the user to that venue. In another example, the system 2 may be configured to encourage a user to go to the gym, initiated by an identified reduction in the frequency of gym visits. Such suggestions can be beneficial in promoting a healthy lifestyle.

Secondly, the system 2 may be configured to suggest to two or more users that they coordinate rides. This suggestion may be presented to the user in the form of a smart phone notification. By analysing historic rides and tracking routes the system 2 can determine regular commutes. A user can be matched to another user(s) according to commute. The profile(s) of a matched user(s) can be provided to the user to enable them to browse their profile and make contact in order to coordinate rides. This feature enables users to learn about their match before making a decision on their suitability for ride coordinating. The system 2 may create matches by pairing users based on history of previous pick-up and drop-off locations. This feature can be extended to create matches for ride coordinating based on attributes. For example, if one user has a history of being dropped off multiple times at a college campus, then other users who have indicated interest in said college may be matched based on the venue and other compatible attributes.

An advantage of this feature is that by coordinating rides, the users can both save money, reduce the traffic, reduce fuel consumption, reduce pollution and encourage socializing. In addition to improving transportation, the system 2 can help people to find others who share similar interests, and give them a platform to meet each other.

Thirdly, the system 2 may be configured to propose venues based on identified matches. This feature can gather users with similar interests by navigating users, deemed to be compatible, to the same venue. This feature may enable the users to meet without the need for prior coordinating of rides.

The following scenario demonstrates an application of this feature. The system 2 identifies a first and a second user with profiles containing compatible attributes. The first user selects a particular club to be navigated to. The second user then searches the system 2 for clubs in the same area. The system 2 responds to the search by anaylsing the second user's profile, selecting profiles of users with compatible attributes who have also searched for clubs in the same area within, for example, an hour of the search. The system 2 identifies a match between the first and second users due to the compatible attributes, location, and time period and then proposes that the second user is navigated to the club which the first user is at. The second user is presented with the matched profile of the first user and is navigated to the club. Alternatively, the second user may be presented with a ranked list of clubs according to frequency of matches located at each club. This is an example of how the system 2 can bring people with similar interests together.

In some examples, the system 2 can match users according to any single attribute provided on a profile, or any combination of attributes. An attribute may include any information derived from previous activity on the system. The system 2 can draw correlations between related attributes to enhance the derivation of matchings. An algorithm may be used by the system 2. The algorithm may learn from the user's entered and/or derived attributes and/or behaviour to tailor future matchings. The behaviour may relate to location history and/or any other information derivable whilst the user has been active on the system 2.

An example of an attribute that can be entered by a user upon the creation of a profile is in-ride communication preference. This can be as simple as a choice between ‘talkative’ or ‘silent’, or can be more specific in nature. The system 2 can match users according to this selection.

The system 2 may enable a user to block another user. In instances where users are repeatedly matched with the same user, it may be preferable to prevent the re-matching. The system 2 provides the user with an option to block another user, thereby preventing any future matching, or consideration in generating a suggestion. This can be useful for a user that finds another user annoying, has a past history with the user, or has legal restraints imposed on another user. Such blocking may result in the user being blocked from matching with any other user or be limited to preventing interactions between the two users involved.

The controller 6 may be configured to analyse the profiles of the two users and use this analysis to generate improved algorithms relating to the generation of matches. The system 2 may use machine learning to refine the algorithm used to produce matches. The matching algorithm may use information such as attributes common to blocked users to improve the accuracy of predicting the compatibility of matches. This can be gradually refined as data is continually collected. As such the system 2 may be configured to learn from successful and unsuccessful matches to improve its assessment of compatibility. Such improvements may involve changing the weighting of particular attributes determined to be more or less influential in predicting compatibility.

Any user profile may be accessible to any other user at any time. Alternatively, profiles may be accessible for a limited duration of time defined by the activity on the system 2. For example, the system 2 may be configured to provide users with access to matched user profiles for the duration of the journey only. Alternatively, users may be allowed to choose from different levels of privacy for their profile.

FIG. 4 shows a method 200 for vehicle navigation. At step 202, users are provided with a sensor 203, which may for example be a GPS sensor on personal device 201, or may be a dedicated sensor issued to a system user. At step 204, location data is collected from each sensor. At step 206, location data is sent to the controller 6 and analysed to produce congregation data. At step 208, the congregation information and location data are used to navigate a vehicle 4 to a venue, the venue being determined using the congregation data.

The method 200 may involve providing each user with a profile and enabling users to input attributes and/or derive attributes from external systems or networks.

Upon deriving congregation information for more than one venue, the step (e) provides users with a list of venues ranked by congregation information. In one example, the venues ranked are selected in response to a user's request to search for a particular type of venue, such as a grocery store.

The method may comprise producing a list of venues by referring to a database of categorised venues and choosing venues which best fit predefined criteria. The predefined criteria may be defined according to attributes, location, congregation data and/or behaviour.

The method may further comprise ranking venues, which may be performed using congregation information. Information in the form of statuses or descriptions of the level of crowding for each venue may be provided by the system 2. The information may convey relative levels of crowding or descriptions based on capacity such as percentage availability.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A vehicle navigation system for a plurality of users, comprising:
a sensor provided to each user of the plurality of users and configured to collect location data;
a controller configured to (1) receive and analyse the location data in order to produce congregation data comprising data on a number of the plurality of users who are congregating at a venue, (2) collect user behavior data of the plurality of users, and (3) provide suggestions of venues which a user of the plurality of users might like to visit based on the collected user behavior data, the user inputting to the controller preferred venue data indicating a preferred venue;
wherein the congregation data, location data, and preferred venue data are used to navigate a vehicle to a venue.

2. A system as claimed in claim 1, wherein the controller is configured to match users of the plurality of users according to attributes.

3. A system as claimed in claim 2, wherein the controller is configured to derive attributes using information collected from external systems or networks.

4. A system as claimed in claim 1, wherein the controller is configured to provide the user with congregation information.

5. (canceled)

6. A system as claimed in claim 1, wherein the controller is configured to provide users of the plurality of users with ranked suggestions of venues.

7. A system as claimed in claim 1, wherein the controller is configured to match users of the plurality of users according to self-entered in-ride communication preferences.

8. A system as claimed in claim 1, wherein the controller is configured to match users of the plurality of users according to correlations in activity and coordinate journeys.

9. A system as claimed in claim 2, wherein the controller is configured to allow users of the plurality of users to block other users of the plurality of users from future matching.

10. A system as claimed in claim 2, wherein the controller is configured to provide users of the plurality of users with access to matched user profiles for a duration of a journey only.

11. A vehicle comprising the vehicle navigation system as claimed in claim 1.

12. A method for vehicle navigation comprising the steps of:
providing a sensor to a plurality of users;
collecting location data from each sensor;
sending the location data to a controller, which is configured to produce congregation data by analysing the location data;
collecting user behaviour data;
providing, to a user of the plurality of users, suggestions of venues which they might like to visit based on the collected user behaviour data;
providing, by the user, preferred venue data indicating a preferred venue; and
using the congregation information and location data to navigate a vehicle to a venue, the venue being determined using the congregation data.

13. A method as claimed in claim 12, further comprising:
providing users of the plurality of users with a profile; and
enabling users of the plurality of users to input attributes and/or deriving attributes from external systems or networks.

14. A method as claimed in claim 12, further comprising the step of:
providing users of the plurality of users with a list of venues ranked by congregation information.

15. A method as claimed in claim 12, further comprising the step of:
providing users of the plurality of users with suggestions of venues to visit, determined by profile, behaviour, and/or congregation information.

16. A method as claimed in claim 12, wherein the controller is configured to provide users of the plurality of users with ranked suggestions of venues.

17. A method as claimed in claim 12, wherein the controller is configured to match users of the plurality of users according to self-entered in-ride communication preferences.

18. A method as claimed in claim 12, wherein the controller is configured to match users of the plurality of users according to correlations in activity and coordinate journeys.

19. A method as claimed in claim 12, wherein the controller is configured to allow users of the plurality of users to block other users of the plurality of users from future matching.

20. A method as claimed in claim 12, wherein the controller is configured to provide users of the plurality of users with access to matched user profiles for a duration of a journey only.

21. A system, comprising:
a plurality of sensors associated with a plurality of users; and
a vehicle navigation system comprising a controller configured to
receive location data from the plurality of sensors,
determine, based on the location data, congregation data comprising data on a number of the plurality of users who are congregating at a venue,
determine user behaviour data of the plurality of users,
determine suggestions of venues which a user of the plurality of users might like to visit based on the user behaviour data,
receive, by a user of the plurality of users, preferred venue data indicating a preferred venue, and
navigate, based on the congregation data, location data, and preferred venue data, a vehicle to a venue.
